(19) United States
(12) Patent Application Publication
(10) Pub. No.: US 2022/0297855 A1
(43) Pub. Date: Sep. 22, 2022

(54) LARGE SPACE SELF-DEPLOYABLE BOOM

(71) Applicant: Harbin Institute of Technology, Heilongjiang (CN)

(72) Inventors: Lifang LI, Heilongjiang City (CN); Pengzhen GUO, Heilongjiang (CN); Zongquan DENG, Heilongjiang (CN); Rongqiang LIU, Heilongjiang (CN); Heng LI, Heilongjiang (CN); Juncai WANG, Heilongjiang (CN); Xiang WEI, Heilongjiang (CN); Shuangyu WANG, Heilongjiang (CN); Yunlong LI, Heilongjiang (CN)

(21) Appl. No.: 17/697,573

(22) Filed: Mar. 17, 2022

(30) Foreign Application Priority Data
Mar. 17, 2021 (CN) 202110287894.7

(51) Int. Cl. B64G 1/22

(52) U.S. Cl. CPC B64G 1/222

(57) ABSTRACT

The present disclosure discloses a large space self-deployable boom. The problems that an existing antenna boom is complicated in structure and inconvenient to unfold or fold are solved. The boom comprises a plurality of stretching units which are coaxial and fixedly connected end to end in sequence, wherein each stretching unit comprises two fixing rings which are coaxially arranged up and down and a plurality of stretching main bodies uniformly distributed between the two fixing rings, the stretching main body is of a spring sheet structure, and when being on the ground, the plurality of stretching main bodies are bent by applying external force so that the folding of the boom is achieved, and the folding state is maintained through rope binding; after entering the outer space, the rope is cut off to realize the self-deployment of the stretching main body, so that the self-deployment of the boom is realized.

### CROSS REFERENCE TO RELATED APPLICATION

This patent application claims the benefit and priority of Chinese Patent Application No. 202110287894.7, filed on Mar. 17, 2021, the disclosure of which is incorporated by reference herein in its entirety as part of the present application.

### TECHNICAL FIELD

The present disclosure relates to a large space self-deployable boom, and belongs to the technical field of satellite antennas.

### BACKGROUND ART

A space boom is an important part of a satellite antenna system, which is a basic one-dimensional deployment structure. As an effective supporting structure, the space boom can be used for large-scale deployable antennas, supporting frames of solar sails and telescopes, space manipulators, space platforms and so on. Whether the antenna boom can be unfolded in place timely and accurately directly affects the success of the whole satellite launch mission. In addition, compared with the satellite platform, as a flexible component, the structural parameters of the antenna boom have a great influence on the dynamic characteristics of the whole antenna system, and then affect other dynamic design indexes of the antenna and the attitude adjustment of the satellite. However, in the prior art, in order to achieve deployment in place timely and accurately, most of the structures used by the antenna boom are relatively complicated, which further leads to a relatively complicated deploying or folding process.

### SUMMARY

The present disclosure further provides a large space self-deployable boom in order to solve the problems that an existing antenna boom is complicated in structure and inconvenient to unfold or fold.

The technical scheme used by the present disclosure to solve the above technical problems is as follows.

The present disclosure relates to a large space self-deployable boom, comprising a plurality of stretching units which are coaxial and fixedly connected end to end in sequence, wherein each stretching unit comprises two fixing rings which are coaxially arranged up and down and a plurality of stretching main bodies uniformly distributed between the two fixing rings 1, the stretching main body is of a spring sheet structure, and when being on the ground, the plurality of stretching main bodies are bent by applying external force so that the folding of the boom is achieved, and the folding state is maintained through rope binding; after entering the outer space, the rope is cut off to realize the self-deployment of the stretching main body, so that the self-deployment of the boom is realized.

Further, every two adjacent stretching units are fixedly connected by a connecting member 3.

Further, the connecting member comprises an inner ring and an outer ring which are coaxially arranged inside and outside, the fixing rings in two adjacent stretching units are inserted between the inner ring and the outer ring, and the inner ring, the fixing ring and the outer ring are riveted.

Further, each inner ring is provided with a plurality of through holes, and the through holes on a plurality of inner rings are provided in one-to-one correspondence.

Further, each inner ring is provided with three through holes, which are uniformly distributed on the corresponding inner ring.

Further, the stretching main body is made of Ni36CrTiAl.

Further, three stretching main bodies are provided in each stretching unit.

Compared with the prior art, the present disclosure has the following effects.

When being on the ground, an appropriate stretching main body is selected to assemble, so as to form the boom with different deploying/folding ratios. The structure is simple, and the folding state can be maintained or self-deployment can be realized only by tying or disconnecting the rope. Compared with the prior art, deploying and folding operations are more convenient, and it is guaranteed that the boom is unfolded in place timely and accurately by selecting the appropriate stretching main body in advance.

### BRIEF DESCRIPTION OF THE DRAWINGS

FIG. 1 is a schematic diagram of an embodiment of a three-dimensional structure in a folded state, in accordance with aspects of the inventive concepts.

FIG. 2 is a schematic front view of the structure in an unfolded state, in accordance with aspects of the inventive concepts.

FIG. 3 is a schematic diagram of an embodiment of a connection of two adjacent stretching units in an unfolded state, in accordance with aspects of the inventive concepts.

FIG. 4 is a schematic diagram of an embodiment of a three-dimensional structure of a stretching unit in an unfolded state, in accordance with aspects of the inventive concepts.

FIG. 5 is a schematic diagram of an embodiment of a three-dimensional structure of a stretching unit in a folded state, in accordance with aspects of the inventive concepts.

FIG. 6 is a schematic diagram of an embodiment of a three-dimensional structure of an inner ring, in accordance with aspects of the inventive concepts.

FIG. 7 is a schematic diagram of an embodiment of a three-dimensional structure of an outer ring, in accordance with aspects of the inventive concepts.

### DETAILED DESCRIPTION OF THE EMBODIMENTS

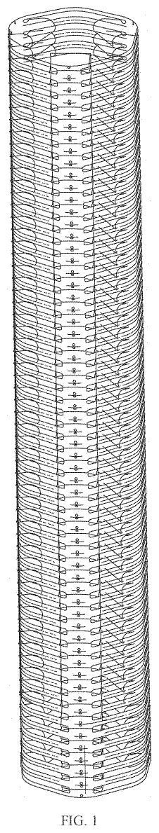

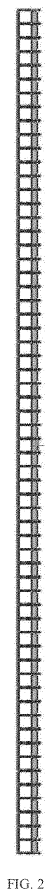

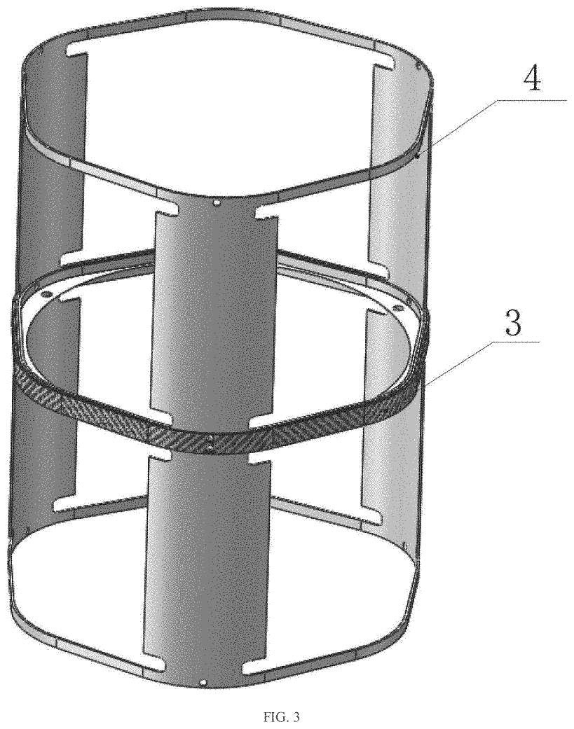

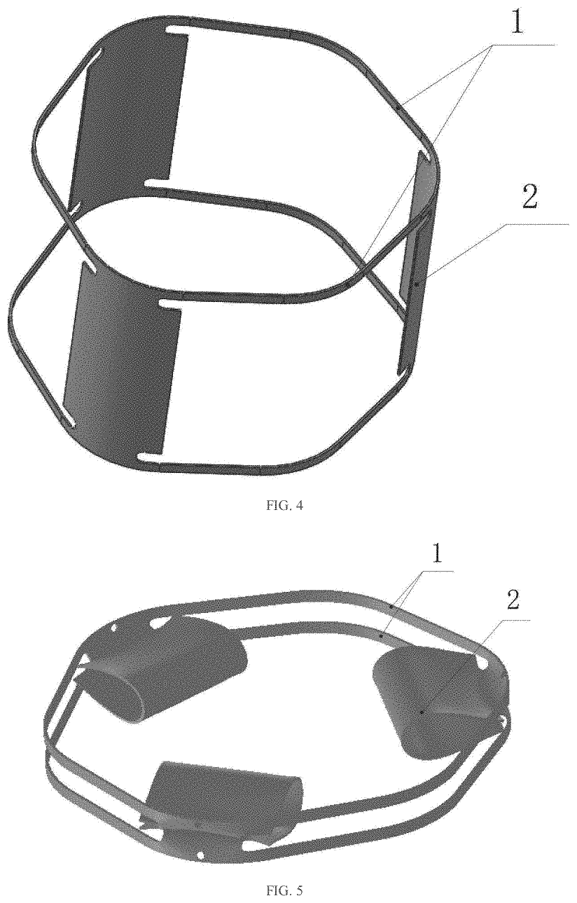

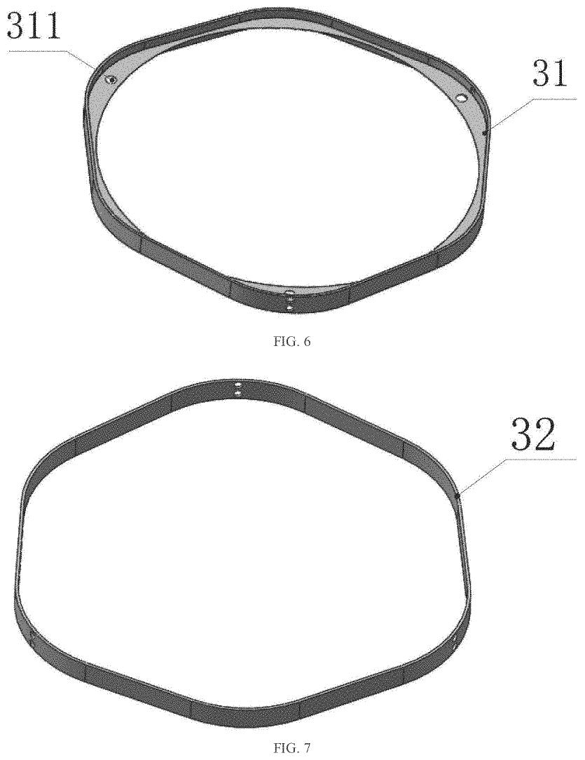

Embodiment 1: This embodiment will be described with reference to FIGS. 1-7. A large space self-deployable boom comprises a plurality of stretching units 4 which are coaxial and fixedly connected end to end in sequence, wherein each stretching unit 4 comprises two fixing rings 1 which are coaxially arranged up and down and a plurality of stretching main bodies 2 uniformly distributed between the two fixing rings 1, the stretching main body 2 is of a spring sheet structure, and when being on the ground, the plurality of stretching main bodies 2 are bent by applying external force so that the folding of the boom is achieved, and the folding state is maintained through rope binding; after entering the outer space, the rope is cut off to realize the self-deployment of the stretching main body 2, so that the self-deployment of the boom is realized.

According to the basic principle of elastic deformation, the present disclosure realizes the folding and deploying of the boom. The radian and length of the spring sheet, as well as the envelope diameter and material formed between the spring sheets directly affect the deploying/folding ratio.

The spring sheet structure is the spring steel sheet structure.

After the boom is folded, a plurality of stretching units 4 are bound with ropes to maintain the basic folded state.

The stretching main body 2 is bent by applying external force so that the boom has a larger deploying/folding ratio.

When being on the ground, an appropriate stretching main body 2 is selected to assemble, so as to form the boom with different deploying/folding ratios. The structure is simple, and the folding state can be maintained or self-deployment can be realized only by tying or disconnecting the rope. Compared with the prior art, deploying and folding operations are more convenient, and it is guaranteed that the boom is unfolded in place timely and accurately by selecting the appropriate stretching main body 2 in advance.

Every two adjacent stretching units 4 are fixedly connected by a connecting member 3, so as to ensure the connection stability of the boom.

The connecting member 3 comprises an inner ring 31 and an outer ring 32 which are coaxially arranged inside and outside, the fixing rings 1 in two adjacent stretching units 4 are inserted between the inner ring 31 and the outer ring 32, and the inner ring 31, the fixing ring 1 and the outer ring 32 are riveted.

Each inner ring 31 is provided with a plurality of through holes 311, and the through holes 311 on a plurality of inner rings 31 are provided in one-to-one correspondence. The through holes 311 are provided to facilitate the passage of ropes.

Each inner ring 31 is provided with three through holes 311, which are uniformly distributed on the corresponding inner ring 31. The through holes 311 are uniformly distributed, which ensures that the stretching unit 4 is uniformly stressed when it is folded, thus ensuring that it can be unfolded timely and accurately when it is self-unfolded.

The plurality of through holes 311 are arranged in one-to-one correspondence or staggered with the plurality of stretching main bodies.

The stretching main body 2 is made of Ni36CrTiAl.

Three stretching main bodies 2 are provided in each stretching unit 4.

What is claimed is:

1. A large space self-deployable boom, comprising
a plurality of stretching units (4) which are coaxial and fixedly connected end to end in sequence, wherein each stretching unit (4) comprises two fixing rings (1) which are coaxially arranged up and down and a plurality of stretching main bodies (2) uniformly distributed between the two fixing rings (1), wherein:
the stretching main body (2) is of a spring sheet structure, and when being on the ground, the plurality of stretching main bodies (2) are bent by applying external force so that the folding of the boom is achieved, and the folding state is maintained through rope binding; and
removal of the rope results in the self-deployment of the stretching main body (2), so that the self-deployment of the boom is realized.

2. The large space self-deployable boom according to claim 1, wherein the stretching main body (2) is made of Ni36CrTiAl.

3. The large space self-deployable boom according to claim 1, wherein every two adjacent stretching units (4) are fixedly connected by a connecting member (3).

4. The large space self-deployable boom according to claim 3, wherein the stretching main body (2) is made of Ni36CrTiAl.

5. The large space self-deployable boom according to claim 3, wherein the connecting member (3) comprises an inner ring (31) and an outer ring (32) which are coaxially arranged inside and outside, and wherein the fixing rings (1) in two adjacent stretching units (4) are inserted between the inner ring (31) and the outer ring (32), and the inner ring (31), the fixing ring (1) and the outer ring (32) are riveted together.

6. The large space self-deployable boom according to claim 5, wherein the stretching main body (2) is made of Ni36CrTiAl.

7. The large space self-deployable boom according to claim 5, wherein each inner ring (31) is provided with a plurality of through holes (311), and the through holes (311) on a plurality of inner rings (31) are provided in one-to-one correspondence.

8. The large space self-deployable boom according to claim 7, wherein the stretching main body (2) is made of Ni36CrTiAl.

9. The large space self-deployable boom according to claim 7, wherein each inner ring (31) is provided with three through holes (311), which are uniformly distributed on the corresponding inner ring (31).

10. The large space self-deployable boom according to claim 9, wherein the stretching main body (2) is made of Ni36CrTiAl.

11. The large space self-deployable boom according to claim 1, wherein three stretching main bodies (2) are provided in each stretching unit (4).
